(19) United States
(12) Patent Application Publication
(10) Pub. No.: US 2026/0252478 A1
(43) Pub. Date: Aug. 27, 2026

(54) METHOD AND SYSTEM FOR AUTOMATED TESTING OF INSURANCE OPERATIONS ACROSS MULTIPLE INSURANCE PRODUCT PLATFORMS

(71) Applicant: LTI Mindtree Ltd, Mumbai (IN)

(72) Inventors: Siddharth Nigam, Mumbai (IN); Vipin Phogat, Mumbai (IN); Sheetal Jadhav, Mumbai (IN)

(21) Appl. No.: 19/243,036

(22) Filed: Jun. 19, 2025

(30) Foreign Application Priority Data
Feb. 21, 2025 (IN) 202521015132

(51) Int. Cl. G06F 11/3698; G06F 11/3668; G06Q 40/08

(52) U.S. Cl. CPC G06F 11/3698; G06F 11/3688; G06Q 40/09

(57) ABSTRACT

A method and system for automated testing of insurance operations related to a plurality of insurance product platforms is disclosed. Test requirements for the insurance operations that span a plurality of insurance product platforms are received through a script-less interface. Test scenarios and associated test data for the insurance operations are generated using a large language model (LLM). The test scenarios and the associated test data are independent of specific implementations of the plurality of insurance product platforms. The test scenarios are translated into platform-specific test instructions for each respective insurance product platform of the plurality of insurance product platforms through a universal command interface. The platform-specific test instructions are concurrently executed across the plurality of insurance product platforms while maintaining a cross-platform execution state, and unified test results are provided across the plurality of insurance products platforms.

### FIELD

Various embodiments of the present disclosure generally relate to testing insurance operations. More particularly, the disclosure relates to a method and system for automated testing of insurance operations across multiple insurance product platforms in a no-code/low-code environment.

### BACKGROUND

In the domain of insurance application testing, traditional automation tools such as Selenium™ and Katalon™ have been widely employed. The tools offer essential functionalities to automate the testing of web-based insurance applications. Specifically, they enable the verification of key features such as form validations, policy management workflows, claims processing mechanisms, and user interface compatibility across multiple browsers. However, these tools are primarily designed for testing within single platforms or technologies, creating significant challenges when insurance applications need to integrate and test functionality across multiple technology providers' platforms. By automating these repetitive and time-intensive tasks, these tools contribute to improving testing efficiency within their specific platform constraints. Despite their utility, such tools are often limited in their adaptability to complex insurance workflows, scalability for large datasets, and integration with modern technologies such as AI-driven analytics or real-time monitoring.

In the industry, insurance carriers often utilize either a single insurance product or multiple insurance products from different technology providers, depending on their specific needs and operational feasibility. Each of these products is typically accompanied by its own automation testing framework, developed using various technologies such as Selenium™, Behavior-Driven Development (BDD), or other specialized tools. This fragmentation of testing environments forces testers to navigate multiple platforms and tools to complete comprehensive testing cycles. While these frameworks effectively address the individual testing needs of their respective products, they create significant challenges when it comes to achieving a unified approach to automation testing across multiple products and platforms. The absence of a universal platform capable of supporting the automation testing of all insurance products under a single umbrella result in inefficiencies, such as redundant effort, inconsistent testing methodologies, increased maintenance costs, and complex cross-platform coordination requirements.

In addition, existing testing frameworks often demand strong programming skills, which significantly restricts the pool of potential users capable of effectively utilizing these tools. This limitation creates a dependency on highly skilled testers, thereby introducing bottlenecks in the automation process. As a result, organizations face challenges in scaling their testing efforts or rapidly onboarding new team members, particularly in the fast-paced insurance sector where time-to-market is critical. The reliance on programming expertise not only increases operational costs but also hinders the democratization of automation testing, making it inaccessible to domain experts, business analysts, or other stakeholders who possess valuable contextual knowledge but lack technical coding skills.

Moreover, maintaining and updating the code within existing testing frameworks becomes increasingly complex as projects grow in scale and complexity. Over time, this complexity often results in the accumulation of technical debt, where quick fixes and workarounds are implemented to address immediate needs at the expense of long-term maintainability. This technical debt not only makes future updates and optimizations more difficult but also increases the likelihood of introducing errors or inconsistencies into the testing framework. The challenges are further compounded in the insurance sector, where regulatory compliance and frequent product updates demand continuous enhancements to testing workflows.

The testing frameworks currently available in the market are primarily designed for generic testing purposes and often fail to address the specific needs of the insurance industry. Insurance applications typically involve complex workflows, such as policy lifecycle management, claims adjudication, underwriting processes, and compliance checks, which demand a specialized approach to testing. Existing frameworks are not tailored to accommodate these unique requirements, resulting in inefficiencies and gaps in test coverage. Moreover, the existing frameworks often comprise lengthy automation cycles due to their inherent complexity and the steep learning curve associated with their usage. This extended timeline undermines the fundamental purpose of automation, which is to deliver time and cost efficiencies while enhancing the quality and scope of testing. The delays in implementation and execution negate the potential benefits of automation, making it difficult for insurance carriers to achieve faster time-to-market, comprehensive test coverage, and reduced operational costs.

Additionally, these testing frameworks often demand a large team of Quality Assurance (QA) testers with specialized technical skills specific to the chosen framework. This dependency on highly skilled personnel not only makes the implementation and maintenance of such frameworks resource-intensive but also significantly increases costs in terms of both time and money. The steep learning curve and reliance on coding expertise further limit the adoption of these frameworks, as organizations may struggle to recruit or train testers with the requisite technical proficiency. This limitation creates a barrier for businesses, particularly those in the insurance industry, to fully embrace automation testing, thereby restricting their ability to scale operations, improving efficiency, and achieve consistent testing quality.

Particularly, existing testing frameworks fall short when it comes to automating complex and specialized testing scenarios in the insurance domain. For example, critical testing requirements such as time-travel testing, which involves simulating policy and claim scenarios across different dates; rate testing, which ensures the accuracy of premium calculations and underwriting logic; and integration testing, which validates seamless communication between interconnected systems, are not adequately addressed by generic existing frameworks. Moreover, the existing frameworks often lack the flexibility to extend automation capabilities to other critical areas, such as kickstarting performance testing to evaluate system scalability and responsiveness under high loads. The inability of traditional frameworks to handle these complex and domain-specific testing requirements results in significant manual effort, inefficiencies, and gaps in test coverage.

Therefore, there is a need for a holistic automation testing mechanism that can address the aforementioned challenges by providing a no-code (script-less) environment for testing multiple insurance operations without the need of any prior automation or technical skills.

### SUMMARY

The present disclosure relates to a method and system for automated testing of insurance operations across a plurality of insurance product platforms. Test requirements for the insurance operations that span a plurality of insurance product platforms are received through a script-less interface. Test scenarios and associated test data for the insurance operations are generated using a large language model (LLM). The test scenarios and the associated test data are independent of specific implementations of the plurality of insurance product platforms. The test scenarios are translated into platform-specific test instructions for each respective insurance product platform of the plurality of insurance product platforms through a universal command interface.

The platform-specific test instructions are concurrently executed across the plurality of insurance product platforms while maintaining a cross-platform execution state, and unified test results are provided across the plurality of insurance products platforms.

### BRIEF DESCRIPTION OF THE FIGURE

FIG. 1 is a diagram that illustrates an exemplary environment within which various embodiments of the present disclosure may function.

FIG. 2 is a diagram that illustrates a system for automated testing of insurance operations across multiple insurance product platforms, in accordance with an embodiment of the present disclosure.

FIG. 3 is a diagram that illustrates a flowchart for a method for automated testing of insurance operations across multiple insurance product platforms, in accordance with an embodiment of the present disclosure.

### DESCRIPTION

Pursuant to various embodiments, the present disclosure relates to a method and system for automated testing of insurance operations across a plurality of insurance product platforms. Test requirements for the insurance operations that span a plurality of insurance product platforms are received through a script-less interface. Test scenarios and associated test data for the insurance operations are generated using an LLM. The test scenarios and the associated test data are independent of specific implementations of the plurality of insurance product platforms. The test scenarios are translated into platform-specific test instructions for each respective insurance product platform of the plurality of insurance product platforms through a universal command interface. The platform-specific test instructions are concurrently executed across the plurality of insurance product platforms while maintaining a cross-platform execution state, and unified test results are provided across the plurality of insurance products platforms.

In one or more embodiments, testing refers to the process of evaluating the functionality, performance, and compliance of a system, application, or platform by executing predefined scenarios, validating expected outcomes, and identifying discrepancies or defects. Testing may involve various methodologies, including automated and manual approaches, and can be applied across multiple environments to ensure reliability, accuracy, and consistency.

In one or more embodiments, insurance operations refer to various processes and workflows associated with the administration, management, and execution of insurance-related activities. The operations may include, but are not limited to, policy issuance, underwriting, claims processing, premium calculations, risk assessments, regulatory compliance checks, and customer service interactions. Insurance operations may be performed across multiple insurance product platforms, each having distinct rules, data structures, and processing requirements.

In one or more embodiments, test requirements refer to the specifications, conditions, and criteria that define the scope and objectives of a testing process. The requirements may include functional and non-functional aspects, such as validation of business rules, system performance, data integrity, security compliance, and interoperability across different platforms. Test requirements may be derived from regulatory guidelines, business logic, user expectations, and industry standards, so that the system under evaluation meets the intended operational benchmarks.

In one or more embodiments, insurance product platforms refer to software applications, or technology infrastructures that facilitate the creation, management, and execution of insurance-related services. The insurance product platforms may support various insurance products, including life, health, property, casualty, and auto insurance, and may encompass policy administration systems, underwriting engines, claims management systems, billing and payment platforms, and customer relationship management (CRM) systems. Insurance product platforms may differ in architecture, data models, processing logic, and regulatory compliance requirements while operating within on-premises, cloud-based, or hybrid environments.

In one or more embodiments, a script-less interface refers to a user-friendly, no-code or low-code interface that enables users to define, configure, and execute test scenarios without requiring manual scripting or programming knowledge. The script-less interface may provide visual elements, such as drag-and-drop components, natural language processing (NLP)-based inputs, or form-based configurations, allowing users to specify test requirements, parameters, and workflows intuitively.

In one or more embodiments, test scenarios refer to predefined or dynamically generated sequences of actions, conditions, and expected outcomes designed to validate the functionality, performance, and compliance of a system or process. Test scenarios define specific use cases, workflows, or business operations to be tested under various conditions, ensuring comprehensive coverage of requirements. The test scenarios may be independent of platform-specific implementations and can be adapted for execution across multiple environments, facilitating consistency in testing and identifying discrepancies or defects in the system under evaluation.

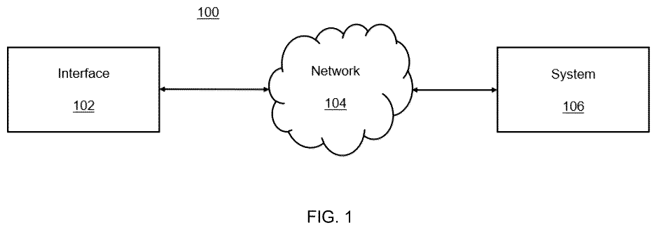

FIG. 1 is a diagram that illustrates an exemplary environment 100, within which various embodiments of the present disclosure may function. Referring to FIG. 1, the environment 100 comprises an interface 102, a network 104, and a system 106.

The interface 102 is a script-less interface that is configured to receive test requirements from a user in various formats, including predefined templates, dropdown selections, and natural language descriptions. The interface 102 supports both manual entry and automated ingestion of test data, facilitating no-code or low-code testing environment. The test requirements that are received are transmitted over the network 104 to the system 106, which processes the requirements.

In one or more embodiments, receiving the test requirements by the interface 102 may include receiving insurance-specific validation rules that govern cross-platform business processes. The validation rules may be provided in formats such as JSON, XML, or spreadsheet-based templates, allowing the user to specify expected behaviors, parameterized test conditions, and business logic constraints.

In one or more embodiments, the validation rules may define the expected behavior of various insurance operations, such as policy administration, claims processing, underwriting, and billing, ensuring that all transactions and dataflows adhere to industry standards and business logic. The interface 102 may further capture dependencies between interconnected modules, such as the relationship between policy issuance and claims adjudication or the synchronization of billing cycles with policy renewals. By mapping the dependencies, the system 106 ensures that test scenarios account for real-world operational conditions, minimizing errors caused by inconsistent data handling across platforms. Additionally, the interface 102 may facilitate the definition of validation checkpoints that align with regulatory compliance requirements, ensuring that all tested operations conform to legal and industry-specific guidelines, such as HIPAA, IFRS 17, or local insurance mandates.

The network 104 refers to a communication infrastructure that enables data exchange between the interface 102 and the system 106. The network 104 may include wired or wireless communication channels, such as the Internet, a local area network (LAN), a wide area network (WAN), or a cloud-based infrastructure. It facilitates seamless transmission of test requirements, execution commands, and test results between the components of the environment 100, ensuring efficient processing and validation of insurance-related operations.

The system 106 offers a no-code platform that is configured to test insurance operations that span a plurality of insurance product platforms, including but not limited to life insurance, health insurance, property and casualty insurance, and annuities. By leveraging a no-code approach, the system 106 enables business users, quality assurance teams, and domain experts to define and execute test cases without requiring extensive programming knowledge.

The system's 106 architecture is designed to facilitate comprehensive testing of dataflows, integrations, and calculations by simulating real-world insurance scenarios, such as underwriting decisions, policy renewals, claims adjudication, and premium calculations. It supports end-to-end validation of business rules, regulatory compliance requirements, and system interoperability, ensuring that insurance applications function correctly under all conditions, including high-load scenarios. Additionally, the system 106 incorporates automated error detection and reporting mechanisms, allowing for rapid identification and resolution of discrepancies in data processing or computational logic.

In some non-limiting embodiments, the system 106 may be built on the Microsoft® Playwright™ library and operate within the Node.js® environment for testing insurance operations. The use of the Node.js® environment allows for scalable execution of test scripts, parallel test execution, and integration with various CI/CD pipelines, making it suitable for continuous testing in agile development workflows.

In one or more embodiments, the system 106 is configured to integrate with other CI/CD tools for seamless workflows, enabling automated testing as part of the software development lifecycle. The system 106 can be integrated with tools such as Jenkins®, GitLab CI/CD™, Azure DevOps®, and GitHub Actions™, allowing for continuous testing, validation, and deployment of insurance applications. By embedding testing into the CI/CD pipeline, the system 106 ensures that every code change, whether related to policy management, claims processing, or compliance updates, is automatically verified before deployment.

In some non-limiting embodiments, though the present disclosure referenced technologies, such as Playwright™, Node.js®, Jenkins®, GitLab CI/CD™, Azure DevOps®, and GitHub Actions™, it is not limited to these specific implementations. Other testing frameworks, execution environments, and CI/CD tools that provide similar or superior functionalities may also be employed within the scope of the disclosure. For instance, the system 106 may leverage alternative open-source or proprietary testing solutions, programming languages, or deployment pipelines, depending on technological advancements, enterprise preferences, or specific operational requirements.

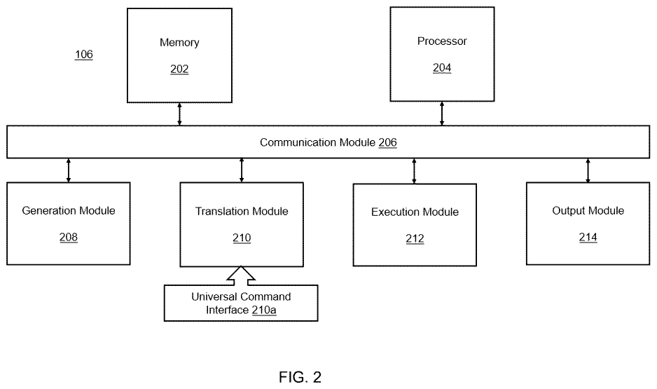

FIG. 2 is a diagram that illustrates the system 106 for automated testing of insurance operations across a plurality of insurance product platforms, in accordance with an embodiment of the present disclosure. Referring to FIG. 2, the system 106 may comprise a memory 202, a processor 204, a communication module 206, a generation module 208, a translation module 210 with a universal command interface 210a, an execution module 212, and an output module 214.

The memory 202 may comprise suitable logic, code, and/or interfaces that may be configured to store instructions (for example, computer-readable program code) that can implement various aspects of the present disclosure.

The processor 204 may comprise suitable logic, code, and/or interfaces that may be configured to execute the instructions stored in the memory 202 to implement various functionalities of the system 106 in accordance with various aspects of the present disclosure. The communication module 206 is configured to facilitate seamless interaction between the processor 204 and various modules within the system 106.

In one or more embodiments, upon receiving the test requirements from the user via the interface 102, the generation module 208 of the system 106 initiates its operation. The generation module 208 may comprise suitable logic, code, and/or interfaces that may be configured to generate actionable test scenarios and associated test data for the insurance operations. In an exemplary embodiment, the generation module 208 may utilize multiple components such as a set of pre-configured templates or rules engines that interpret the test requirements and apply them to the context of the insurance operations.

In one or more embodiments, the test scenarios generated by the generation module 208 represent different possible use cases and scenarios that the insurance applications may encounter during real-world operations. The test scenarios may include validating the integration of various insurance modules, testing how data flows between policy administration, claims processing, and billing systems, and ensuring that each system operates correctly under different conditions, such as different types of insurance products or varying data inputs.

In addition to the test scenarios, the generation module 208 also creates the associated test data that will be used to validate the performance and accuracy of the insurance operations. The associated test data includes data such as customer profiles, policy details, claim history, and payment records, which are essential for ensuring that the tests accurately replicate real-world conditions. The generation module 208 is equipped to generate this data based on the specific requirements and parameters set by the user, ensuring it matches the test scenarios.

In one or more embodiments, the test scenarios and the associated test data are designed to be independent of the specific implementations of the plurality of insurance product platforms. This refers that the test scenarios and the associated test data are structured in a way that is agnostic to the underlying technical details and architectures of the various insurance product platforms. For instance, the test scenarios and the associated test data are generalized to accommodate a broad range of insurance systems, whether they are custom-built, commercial, or a mix of different technologies.

In one or more embodiments, the generation module 208 leverages an LLM to generate the test scenarios and associated test data. By utilizing an LLM, the generation module 208 is able to analyze complex natural language inputs from the user, such as requirements and business rules, and translate them into structured, actionable test cases that are relevant to the insurance operations. The LLM is specifically trained based on vast corpora of insurance-specific documents, including policy definitions, claims procedures, underwriting guidelines, and compliance regulations, enabling it to contextualize and refine test scenarios that align with real-world insurance workflows. Moreover, the LLM can infer implicit dependencies between different insurance processes and suggest test cases that go beyond explicit user inputs, ensuring a more comprehensive test coverage.

In one or more embodiments, generating test scenarios includes analyzing, by the LLM, business requirements and training data to generate test data along with corresponding test steps. The LLM processes structured and unstructured elements of business requirements, including API documentation, and underwriting rules, to establish relationships between various system components. Based on the identified requirements, the LLM generates test scripts specific to a platform, ensuring that the test scenarios align with platform-specific business logic. By leveraging contextual understanding from training data, the LLM ensures that the generated test scenarios accurately validate platform-specific insurance operations.

Upon analyzing the product specifications, the LLM identifies the critical workflows that span across multiple platforms, such as policy creation, claims processing, premium calculations, and billing. The workflows are typically interconnected, requiring validation across several touchpoints between platforms to ensure consistency and accuracy. For instance, when a new policy is created in the policy administration system, the LLM generates test scenarios that verify whether the correct premium is calculated, the policy details are accurately reflected in the billing system, and any subsequent claims are processed based on the correct policy terms. Similarly, in claims processing, the LLM identifies dependencies on prior transactions, ensuring that claim settlements adhere to the policy's original underwriting terms and premium adjustments.

In one or more embodiments, the generated test scenarios are designed to be platform-agnostic, allowing them to be applied across various insurance product platforms including but not limited to claims processing, billing, underwriting, and settlement systems.

Thereafter, the generation module 208 creates test data variations based on insurance policy rules and regulatory requirements to validate structured documents during product upgrades. The generation module 208 takes into account various policy types, including health, life, and property insurance, as well as the associated rules and guidelines governing each type.

In one or more embodiments, the test data variations are generated by analyzing the core insurance policy rules, such as premium calculations, claims handling processes, policy renewals, and exclusions. The generation module 208 ensures that these variations cover a wide range of potential edge cases and different combinations of policy conditions, such as varying coverage levels, deductibles, and customer demographics.

Additionally, the generation module 208 incorporates regulatory requirements into the test data creation process. For instance, the requirements may include industry-specific compliance mandates, such as those related to data privacy (e.g., GDPR or HIPAA), anti-money laundering checks, solvency requirements, and other legal obligations that must be adhered to in the insurance industry.

The test data variations generated by the system 106 serve to validate structured documents such as policy documents, claims forms, underwriting records, and billing statements.

For example, in the case of policy documents, the system 106 generates test variations to verify different policy types (e.g., term insurance, health insurance, vehicle insurance), customer details (e.g., age, gender, location), and premium calculations under various conditions (e.g., discounts, riders, exclusions). Similarly, for claims forms, the system 106 creates variations to test different claim types (e.g., hospitalization, accident, property damage), ensuring that the platform correctly processes, approves, or denies claims based on policy coverage.

In underwriting records, test variations simulate risk assessment scenarios such as verifying if a high-risk applicant receives accurate policy terms. Likewise, for billing statements, the system 106 validates premium calculations, due dates, late fee applications, and payment allocations to ensure compliance with regulatory and business rules.

In some non-limiting embodiments, the LLM is trained on vast amounts of domain-specific knowledge, which includes industry standards, regulatory requirements, and insurance-specific terminology. As a result, it can automatically generate test cases that align with common insurance business processes such as policy administration, claims management, underwriting, and billing.

The translation module 210 may comprise suitable logic, code, and/or interfaces that may be configured to translate the test scenarios into platform-specific test instructions for each respective insurance product platform of the plurality of insurance product platforms.

In one or more embodiments, the translation module 210 utilizes a set of predefined templates or mapping rules that are tailored to the specific requirements and structures of each insurance product platform. The rules allow the translation module 210 to adapt the generic, platform-agnostic test scenarios into test instructions that are compatible with the individual platform's functionality, data formats, and application interfaces.

In one or more embodiments, the associated test data is stored separately from test execution instructions. By storing the test data and execution instructions in distinct storage locations, the system 106 can more easily manage, update, and scale its testing capabilities without the risk of causing redundancies.

In one or more embodiments, the translation module 210 leverages a universal command interface 210a to translate the test scenarios into platform-specific test instructions. The universal command interface 210a acts as a central mediator between the high-level platform-agnostic test scenarios and the specific instructions required by each insurance product platform. The universal command interface 210a maintains a comprehensive mapping repository that associates insurance operations with their respective platform-specific implementations.

Additionally, the universal command interface 210a is designed to dynamically update element identification strategies based on platform changes. In the context of insurance product platforms, element identification could refer to any UI or backend element such as form fields, buttons, or API endpoints that the test scenarios interact with. As platforms undergo updates, the universal command interface 210a automatically adjusts these strategies to ensure that elements are correctly identified and manipulated.

In one or more embodiments, another key function of the universal command interface 210a is to manage data transformation rules between different insurance product platforms. The universal command interface 210a facilitates the conversion of data from one format to another, ensuring that the test data, which may be platform-agnostic at the start, is appropriately adapted to each platform's data handling requirements.

In one or more embodiments, the universal command interface 210a is responsible for performing automated accessibility and compliance validations. As part of the testing process, it checks that each insurance product platform adheres to the relevant regulatory and accessibility standards. For example, it may ensure that platforms comply with industry regulations such as GDPR, HIPAA, or specific financial regulations, while also verifying that platforms meet accessibility requirements such as WCAG (Web Content Accessibility Guidelines).

The execution module 212 may comprise suitable logic, code, and/or interfaces that may be configured to execute the platform-specific test instructions concurrently across the plurality of insurance product platforms while maintaining a cross-platform execution state.

In one or more embodiments, executing the platform-specific instructions by the execution module 212 includes coordinating test execution across policy administration, claims processing, and billing platforms. The coordination ensures that test scenarios are seamlessly executed across the entire insurance workflow, spanning the critical processes involved in policy management, claims handling, and billing. The execution module 212 effectively performs ‘time travel’ execution, a technique to validate policy lifecycle events by simulating different points in time across the policy's duration. This allows for thorough testing of time-sensitive processes, such as policy renewals, claim approvals, and premium adjustments, so that all policy events are accurately processed and validated within the system.

Additionally, the execution module 212 validates external rater integrations, which are crucial for accurate premium calculations across insurance platforms. By performing the validations, the execution module 212 enables that insurance products remain competitively priced and that premiums are calculated according to the correct formulas and external data inputs.

In one or more embodiments, execution module 212 also focuses on maintaining data consistency during cross-platform operations. As insurance product platforms may operate in heterogeneous environments with varying data formats and structures, the execution module 212 ensures that data integrity is preserved throughout the testing process.

In one or more embodiments, the execution module 212 conducts visual regression testing for user interface validations. Visual regression testing involves capturing screenshots of the user interface at different stages of the test execution and comparing them to baseline images to detect any unintended visual changes.

Furthermore, the system 106 is designed to automatically adapt to user interface changes across the plurality of insurance product platforms. The adaptability is crucial for maintaining the robustness and flexibility of the testing process, as UI elements often change due to platform updates, redesigns, or modifications to underlying web technologies. The system 106 may utilize techniques, such as object recognition and dynamic element mapping, to identify and interact with user interface elements in a way that does not rely on static identifiers.

Additionally, the system 106 ensures test execution stability during platform upgrades. As insurance platforms evolve and release updates, there is always the potential for new features, bug fixes, or architectural changes to affect the behavior of the platform. To address this challenge, the system 106 incorporates dynamic testing methodologies that can detect and respond to changes in the platform environment.

In one or more embodiments, the system 106 provides real-time execution analytics through cloud-based execution. By leveraging the cloud, the system 106 can offer real-time monitoring, logging, and reporting of test execution progress. Cloud-based execution also facilitates scalability, allowing the system 106 to process large volumes of tests across multiple platforms simultaneously without overloading local resources.

The output module 214 may comprise suitable logic, code, and/or interfaces that are configured to provide unified test results across the plurality of insurance product platforms. The output module 214 aggregates test results from different insurance platforms into a single, cohesive report, which includes key performance indicators (KPIs), validation statuses, error logs, and any other relevant data from the test execution process.

In one or more embodiments, providing the unified test results by the output module 214 includes generating cross-platform transaction traces for insurance operations. The transaction traces offer a comprehensive view of the sequence of operations across different insurance product platforms, helping to pinpoint where any discrepancies or errors might occur during the process.

Additionally, the output module 214 validates data consistency across policy administration, claims processing, and billing platforms to ensure that data generated or modified in one platform is consistent with the corresponding data across other platforms. Any discrepancies between the platforms are flagged, allowing for immediate investigation and correction.

In one or more embodiments, the output module 214 also tracks regulatory compliance verification results, ensuring that the insurance operations are aligned with industry regulations and legal requirements. The output module 214 may automatically flag areas where the platform's actions deviate from compliance standards, allowing organizations to address potential compliance issues proactively.

In one or more embodiments, the output module 214 maintains audit trails of cross-platform insurance operations. The audit trails provide a comprehensive log of all actions taken during the test execution, including who performed the actions, what changes were made, and when they occurred.

### Exemplary Embodiment

Consider an insurance provider, Insure-Life Ltd., which offers multiple insurance products, including term insurance, health insurance, and vehicle insurance. Insure-Life Ltd. manages its policy purchase, claims processing, verification, and disbursement operations across multiple insurance product platforms, each built by different technology providers (e.g., Tech Provider 1, Tech Provider 2, & Tech Provider 3). These platforms have distinct data structures, workflows, and APIs, requiring unique testing frameworks.

Traditionally, testing these integrated insurance products would require:
Writing and maintaining separate test scripts for each platform
Managing multiple testing tools and environments
Coordinating test execution across platforms
Reconciling different data formats and structures
Deep technical knowledge of each platform's specific APIs and frameworks

Using the disclosed system 106, a test engineer provides high-level test requirements through the script-less interface 102. For example, the engineer may specify:
“Test the policy purchase flow for term insurance, validate premium calculations, and ensure successful claim disbursement.”

Upon receiving the test requirements, the generation module 208, leveraging an LLM, automatically generates platform-agnostic test scenarios and associated test data. The LLM understands insurance domain terminology, regulatory requirements, and complex business rules to create comprehensive test scenarios. It automatically identifies dependencies between different insurance operations (e.g., policy issuance affecting claims processing) and generates appropriate test data and validation points. The test scenarios are designed to be independent of specific implementations of the underlying platforms while maintaining compliance with insurance industry standards.

For example, the generation module 208 may generate the following test scenario:
“A customer purchases a term insurance policy with a premium of $500 per year. The system should verify the calculated premium, process the payment, and generate a policy document.

The associated test data is stored separately from execution logic, ensuring reusability and modularity across different platforms.

The test scenario is then passed to the translation module 210, which, using the universal command interface 210a, translates it into platform-specific test instructions. The universal command interface 210a maintains a mapping of platform-agnostic insurance operations to platform-specific implementations, handling differences in:
API structures and authentication mechanisms
Data formats and field mappings
Platform-specific constraints and limitations
Response handling and error scenarios

For instance,
If the policy purchase module is on Platform A (Tech Provider 1), the translation module 210 generates corresponding test scripts for web-based automation, handling platform-specific form validations and document uploads.
If the claim disbursement module is on Platform B (Tech Provider 2), it generates corresponding scripts for mobile automation, including device-specific commands and UI interactions.
If premium calculations are handled via Platform C (Tech Provider 3), it generates related API test cases with appropriate data transformations and validation logic.

For example:
The policy purchase flow is tested on Platform A
The premium validation is executed on Platform C, and
The claim disbursement flow runs on Platform B.

The execution module 212 facilitates real-time synchronization between different execution environments and maintains a unified execution state, ensuring test steps are completed in the expected sequence across platforms. The execution module 212:
Manages dependencies between cross-platform operations.
Handles platform-specific timeouts and retry mechanisms.
Maintains transaction integrity across platforms.
Provides real-time visibility into test execution across all platforms.
Automatically handles error recovery and rollback procedures.

Once the execution is complete, the output module 214 consolidates the test results across all platforms into a single unified report. The report includes:
Pass/Fail Status for Each Test Case
Platform-Specific Execution Logs
Detected Anomalies & Inconsistencies
Cross-Platform Validation Insights

For instance, if Platform B fails the policy issuance test but Platform A succeeds, the system 106 will highlight the discrepancy for further investigation.

The test engineer can review the consolidated results without needing to interpret logs for individual platforms, making the testing process highly efficient, scalable, and platform-agnostic.

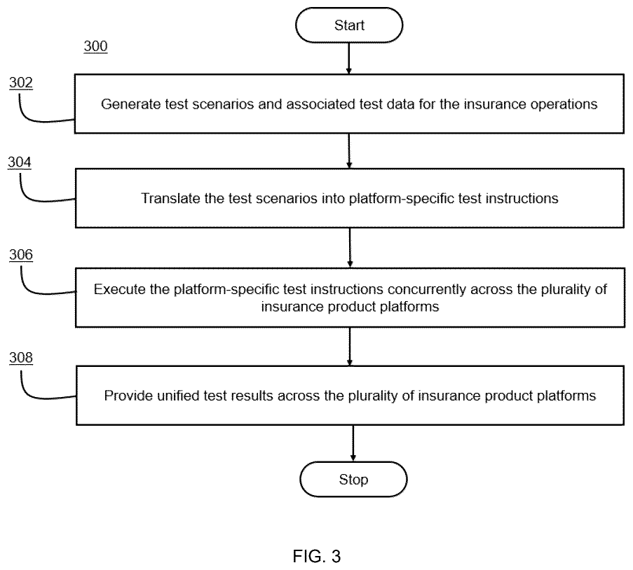

FIG. 3 is a diagram that illustrates a flowchart 300 for a method for automated testing of insurance operations across multiple insurance product platforms, in accordance with an embodiment of the present disclosure.

Upon receiving the test requirements from the user via the interface 102, the generation module 208 of the system 106 initiates its operation.

At 302, the generation module 208 generates test scenarios and associated test data for the insurance operations. In an exemplary embodiment, the generation module 208 may utilize multiple components such as a set of pre-configured templates or rules engines that interpret the test requirements and apply them to the context of the insurance operations.

In one or more embodiments, the test scenarios generated by the generation module 208 represent different possible use cases and scenarios that the insurance applications may encounter during real-world operations. The test scenarios may include validating the integration of various insurance modules, testing how data flows between policy administration, claims processing, and billing systems, and ensuring that each system operates correctly under different conditions, such as different types of insurance products or varying data inputs.

In addition to the test scenarios, the generation module 208 also creates the associated test data that will be used to validate the performance and accuracy of the insurance operations. The associated test data includes data such as customer profiles, policy details, claim history, and payment records, which are essential for ensuring that the tests accurately replicate real-world conditions. The generation module 208 is equipped to generate this data based on the specific requirements and parameters set by the user, ensuring it matches the test scenarios.

In one or more embodiments, the test scenarios and the associated test data are designed to be independent of the specific implementations of the plurality of insurance product platforms. This refers that the test scenarios and the associated test data are structured in a way that is agnostic to the underlying technical details and architectures of the various insurance product platforms. For instance, the test scenarios and the associated test data are generalized to accommodate a broad range of insurance systems, whether they are custom-built, commercial, or a mix of different technologies.

In one or more embodiments, the generation module 208 leverages an LLM to generate the test scenarios and associated test data. By utilizing an LLM, the generation module 208 is able to analyze complex natural language inputs from the user, such as requirements and business rules, and translate them into structured, actionable test cases that are relevant to the insurance operations. The LLM is specifically trained based on vast corpora of insurance-specific documents, including policy definitions, claims procedures, underwriting guidelines, and compliance regulations, enabling it to contextualize and refine test scenarios that align with real-world insurance workflows. Moreover, the LLM can infer implicit dependencies between different insurance processes and suggest test cases that go beyond explicit user inputs, ensuring a more comprehensive test coverage.

In one or more embodiments, generating test scenarios includes analyzing, by the LLM, insurance product specifications to identify test flows across multiple insurance product platforms, and generating platform-agnostic test steps that validate cross-platform insurance operations. The LLM processes structured and unstructured elements of product specifications, including API documentation, data schemas, process flow diagrams, and underwriting rules, to establish relationships between various system components. It identifies key functional points where data transitions between different insurance platforms such as from a policy administration system to a claims processing system and confirms that the generated test scenarios account for variations in data formats, business logic, and system constraints across these platforms. By abstracting platform-specific dependencies, the LLM creates test scenarios that validate cross-platform operations without requiring customization for each underlying insurance product.

Upon analyzing the product specifications, the LLM identifies the critical workflows that span across multiple platforms, such as policy creation, claims processing, premium calculations, and billing. The workflows are typically interconnected, requiring validation across several touchpoints between platforms to ensure consistency and accuracy. For instance, when a new policy is created in the policy administration system, the LLM generates test scenarios that verify whether the correct premium is calculated, the policy details are accurately reflected in the billing system, and any subsequent claims are processed based on the correct policy terms. Similarly, in claims processing, the LLM identifies dependencies on prior transactions, ensuring that claim settlements adhere to the policy's original underwriting terms and premium adjustments.

In one or more embodiments, the generated test steps are designed to be platform-agnostic, allowing them to be applied across various insurance product platforms including but not limited to claims processing, billing, underwriting, and settlement systems.

Thereafter, the generation module 208 creates test data variations based on insurance policy rules and regulatory requirements to validate structured documents during product upgrades. The generation module 208 takes into account various policy types, including health, life, and property insurance, as well as the associated rules and guidelines governing each type.

In one or more embodiments, the test data variations are generated by analyzing the core insurance policy rules, such as premium calculations, claims handling processes, policy renewals, and exclusions. The generation module 208 ensures that these variations cover a wide range of potential edge cases and different combinations of policy conditions, such as varying coverage levels, deductibles, and customer demographics.

At 304, the test scenarios are translated into platform-specific test instructions for each respective insurance product platform of the plurality of insurance product platforms, by the translation module 210.

In one or more embodiments, the translation module 210 utilizes a set of predefined templates or mapping rules that are tailored to the specific requirements and structures of each insurance product platform. The rules allow the translation module 210 to adapt the generic, platform-agnostic test scenarios into test instructions that are compatible with the individual platform's functionality, data formats, and application interfaces.

In one or more embodiments, the associated test data is stored separately from test execution instructions. By storing the test data and execution instructions in distinct storage locations, the system 106 can more easily manage, update, and scale its testing capabilities without the risk of causing redundancies.

In one or more embodiments, the translation module 210 leverages a universal command interface 210a to translate the test scenarios into platform-specific test instructions. The universal command interface 210a acts as a central mediator between the high-level platform-agnostic test scenarios and the specific instructions required by each insurance product platform. The universal command interface 210a maintains a comprehensive mapping repository that associates insurance operations with their respective platform-specific implementations.

Additionally, the universal command interface 210a is designed to dynamically update element identification strategies based on platform changes. In the context of insurance product platforms, element identification could refer to any UI or backend element such as form fields, buttons, or API endpoints that the test scenarios interact with. As platforms undergo updates, the universal command interface automatically adjusts these strategies to ensure that elements are correctly identified and manipulated.

In one or more embodiments, another key function of the universal command interface 210a is to manage data transformation rules between different insurance product platforms. The universal command interface 210a facilitates the conversion of data from one format to another, ensuring that the test data, which may be platform-agnostic at the start, is appropriately adapted to each platform's data handling requirements.

At 306, the execution module 212 executes the platform-specific test instructions concurrently across the plurality of insurance product platforms.

In one or more embodiments, executing the platform-specific instructions by the execution module 212 includes coordinating test execution across policy administration, claims processing, and billing platforms. The coordination ensures that test scenarios are seamlessly executed across the entire insurance workflow, spanning the critical processes involved in policy management, claims handling, and billing. The execution module 212 effectively performs ‘time travel’ execution, a technique to validate policy lifecycle events by simulating different points in time across the policy's duration. This allows for thorough testing of time-sensitive processes, such as policy renewals, claim approvals, and premium adjustments, so that all policy events are accurately processed and validated within the system.

Additionally, the execution module 212 validates external rater integrations, which are crucial for accurate premium calculations across insurance platforms. By performing the validations, the execution module 212 enables that insurance products remain competitively priced and that premiums are calculated according to the correct formulas and external data inputs.

In one or more embodiments, execution module 212 also focuses on maintaining data consistency during cross-platform operations. As insurance product platforms may operate in heterogeneous environments with varying data formats and structures, the execution module 212 ensures that data integrity is preserved throughout the testing process.

In one or more embodiments, the execution module 212 conducts visual regression testing for user interface validations. Visual regression testing involves capturing screenshots of the user interface at different stages of the test execution and comparing them to baseline images to detect any unintended visual changes.

Furthermore, the system 106 is designed to automatically adapt to user interface changes across the plurality of insurance product platforms. The adaptability is crucial for maintaining the robustness and flexibility of the testing process, as UI elements often change due to platform updates, redesigns, or modifications to underlying web technologies. The system 106 may utilize techniques, such as object recognition and dynamic element mapping, to identify and interact with user interface elements in a way that does not rely on static identifiers.

Additionally, the system 106 ensures test execution stability during platform upgrades. As insurance platforms evolve and release updates, there is always the potential for new features, bug fixes, or architectural changes to affect the behavior of the platform. To address this challenge, the system 106 incorporates dynamic testing methodologies that can detect and respond to changes in the platform environment.

In one or more embodiments, the system 106 provides real-time execution analytics through cloud-based execution. By leveraging the cloud, the system 106 can offer real-time monitoring, logging, and reporting of test execution progress. Cloud-based execution also facilitates scalability, allowing the system 106 to process large volumes of tests across multiple platforms simultaneously without overloading local resources.

At 308, the output module 214 provides unified test results across the plurality of insurance product platforms. The output module 214 aggregates test results from different insurance platforms into a single, cohesive report, which includes key performance indicators (KPIs), validation statuses, error logs, and any other relevant data from the test execution process.

In one or more embodiments, providing the unified test results by the output module 214 includes generating cross-platform transaction traces for insurance operations. The transaction traces offer a comprehensive view of the sequence of operations across different insurance product platforms, helping to pinpoint where any discrepancies or errors might occur during the process.

The method and system disclosed herein is advantageous in that it provides a universal command interface that dynamically adapts to multiple insurance platforms without requiring platform-specific modifications. Unlike conventional testing frameworks that demand separate automation scripts for each platform, the universal command interface creates an abstraction layer that translates platform-agnostic test scenarios into platform-specific instructions for diverse insurance ecosystems such as Duck Creek™, Majesco™, and Guidewire™. This significantly reduces maintenance overhead and eliminates the need for multiple testing frameworks, as test scenarios remain independent of underlying platform implementations.

Furthermore, the method and system is advantageous in that it enables synchronized cross-platform test execution through an intelligent state management system. The system maintains execution state coherence across policy administration, claims processing, and billing platforms, while automatically handling complex insurance workflows through time-travel execution capabilities. This enables comprehensive testing of time-sensitive insurance operations, such as policy renewals and claim settlements, across multiple platforms without manual intervention or coordination.

Additionally, the method and system is advantageous in that it leverages an LLM specifically trained on insurance domain knowledge to automatically generate platform-agnostic test scenarios from natural language requirements. The LLM's understanding of insurance-specific terminology, workflows, and regulatory requirements enables it to identify implicit dependencies between insurance operations and generate comprehensive test scenarios that validate cross-platform interactions. This eliminates the need for specialized technical expertise in creating and maintaining test scripts while ensuring thorough coverage of complex insurance workflows.

The method and system is further advantageous in that it provides a unified test data management framework that maintains data consistency across heterogeneous insurance platforms. The system automatically handles data transformations between different platform-specific formats while preserving relationships between policy, claims, and billing data. This ensures accurate validation of complex insurance calculations, regulatory compliance, and business rules across platforms without requiring manual data reconciliation or platform-specific data handling logic.

Moreover, the method and system is advantageous in that it implements intelligent visual regression testing specifically designed for insurance applications. The system automatically identifies and excludes dynamic content such as policy numbers, timestamps, and calculated values during visual comparison, while focusing on critical UI elements that must remain consistent across platforms. This ensures accurate validation of insurance-specific interfaces such as policy documents, claim forms, and billing statements across different platforms and versions, reducing false positives caused by legitimate dynamic content changes while catching actual visual discrepancies that could impact user experience or regulatory compliance.

Furthermore, the method and system is advantageous in that it incorporates automated quality audits through integration with Google Lighthouse™, enabling comprehensive validation of insurance platform performance, accessibility, and best practices in a standardized manner across different insurance products. The system automatically evaluates critical aspects such as page load performance for policy quote forms, accessibility compliance for customer-facing insurance portals, and security best practices for sensitive insurance data handling. This automated assessment ensures consistent quality standards across all insurance platforms while reducing the manual effort required for compliance verification and performance monitoring.

While this innovation is primarily designed for insurance application automation, its underlying architecture and methodology enable seamless adaptability across multiple sectors, including finance, banking, and commercial web applications. The system's platform-agnostic design, coupled with its modular testing framework, allows it to accommodate diverse business logic, regulatory requirements, and operational workflows beyond the insurance domain. In finance and banking, the system can automate the testing of loan processing, fraud detection, transaction validations, and compliance reporting, ensuring accuracy and regulatory adherence. Similarly, in commercial web applications, it facilitates end-to-end functional testing, API validations, UI consistency checks, and load testing to enhance performance and user experience. The system's ability to dynamically adapt to domain-specific rules, integrate with diverse technology stacks, and support cross-platform testing makes it a versatile solution for enterprises seeking robust and scalable automation.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of the ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A system for automated testing of insurance operations, comprising:
a processor;
a memory storing instructions that, when executed by the processor, configure the system to:
receive, through a script-less interface, test requirements for insurance operations that span a plurality of insurance product platforms;
generate, using a large language model (LLM), test scenarios and associated test data for the insurance operations, wherein the test scenarios and the associated test data are independent of specific implementations of the plurality of insurance product platforms;
translate, through a universal command interface, the test scenarios into platform-specific test instructions for each respective insurance product platform of the plurality of insurance product platforms, wherein the associated test data is stored separately from test execution instructions;
execute the platform-specific test instructions concurrently across the plurality of insurance product platforms while maintaining a cross-platform execution state; and
provide unified test results across the plurality of insurance product platforms.

2. The system of claim 1, wherein receiving the test requirements further comprises:
receiving, through the script-less interface, insurance-specific validation rules for cross-platform business processes;
capturing dependencies between policy administration, claims processing, and billing operations; and
defining validation checkpoints for regulatory compliance requirements.

3. The system of claim 1, wherein generating the test scenarios comprises:
analyzing, by the LLM, insurance product specifications to identify test flows spanning multiple insurance product platforms;
generating platform-agnostic test steps that validate cross-platform insurance operations;
creating test data variations based on insurance policy rules and regulatory requirements; and
validating structured documents during product upgrades.

4. The system of claim 1, wherein the universal command interface:
maintains a mapping repository of insurance operations to platform-specific implementations;
dynamically updates element identification strategies based on platform changes;
manages data transformation rules between different insurance product platforms; and
performs automated accessibility and compliance validations.

5. The system of claim 1, wherein executing the platform-specific test instructions comprises:
coordinating test execution across policy administration, claims processing, and billing platforms;
performing time travel execution to validate policy lifecycle events;
validating external rater integrations for premium calculations;
maintaining data consistency during cross-platform operations; and
executing visual regression testing for user interface validations.

6. The system of claim 5, further comprising:
automatically adapting to user interface changes across the plurality of insurance product platforms;
handling dynamic web elements within each insurance product platform;
maintaining test execution stability during platform upgrades; and
providing real-time execution analytics through cloud-based execution.

7. The system of claim 1, wherein providing the unified test results comprises:
generating cross-platform transaction traces for insurance operations;
validating data consistency across policy, claims, and billing platforms;
tracking regulatory compliance verification results; and
maintaining audit trails of cross-platform insurance operations.

8. A computer-implemented method for automated testing of insurance operations, comprising:
receiving, by a processor, through a script-less interface, test requirements for insurance operations that span a plurality of insurance product platforms;
generating, by the processor, using a large language model (LLM), test scenarios and associated test data for the insurance operations, wherein the test scenarios and the associated test data are independent of specific implementations of the plurality of insurance product platforms;
translating, by the processor, through a universal command interface, the test scenarios into platform-specific test instructions for each respective insurance product platform of the plurality of insurance product platforms, wherein the associated test data is stored separately from test execution instructions;
executing, by the processor, the platform-specific test instructions concurrently across the plurality of insurance product platforms while maintaining a cross-platform execution state; and
providing unified test results across the plurality of insurance product platforms.

9. The method of claim 8, wherein receiving the test requirements comprises:
receiving, through the script-less interface, insurance-specific validation rules for cross-platform business processes;
capturing dependencies between policy administration, claims processing, and billing operations; and
defining validation checkpoints for regulatory compliance requirements.

10. The method of claim 8, wherein generating the test scenarios comprises:
analyzing, by the LLM, insurance product specifications to identify test flows spanning multiple insurance product platforms;
generating platform-agnostic test steps that validate cross-platform insurance operations;
creating test data variations based on insurance policy rules and regulatory requirements; and
validating structured documents during product upgrades.

11. The method of claim 8, wherein translating through the universal command interface comprises:
maintaining a mapping repository of insurance operations to platform-specific implementations;
dynamically updating element identification strategies based on platform changes;
managing data transformation rules between different insurance product platforms; and
performing automated accessibility and compliance validations.

12. The method of claim 8, wherein executing the platform-specific test instructions comprises:
coordinating test execution across policy administration, claims processing, and billing platforms;
performing time travel execution to validate policy lifecycle events;
validating external rater integrations for premium calculations;
maintaining data consistency during cross-platform operations; and
executing visual regression testing for user interface validations.

13. The method of claim 12 further comprising:
automatically adapting to user interface changes across the plurality of insurance product platforms;
handling dynamic web elements within each insurance product platform;
maintaining test execution stability during platform upgrades; and
providing real-time execution analytics through cloud-based execution.

14. The method of claim 8, wherein providing the unified test results comprises:
generating cross-platform transaction traces for insurance operations;
validating data consistency across policy, claims, and billing platforms;
tracking regulatory compliance verification results; and
maintaining audit trails of cross-platform insurance operations.
